(19) United States
(12) Patent Application Publication
(10) Pub. No.: US 2026/0104709 A1
(43) Pub. Date: Apr. 16, 2026

(54) METHODS FOR ADAPTIVE MOWING CONTROL OF MOWING ROBOTS

(71) Applicants: ZHEJIANG SAFUN INDUSTRIAL CO., LTD., Yongkang (CN); ZHEJIANG KUOCHUANG TECHNOLOGY CO., LTD, Yongkang (CN)

(72) Inventors: Liangliang SUN, Yongkang (CN); Yiheng YING, Yongkang (CN); Kuo YING, Yongkang (CN); Dong CUI, Yongkang (CN); Jianbing GUO, Yongkang (CN); Linqiang ZHUANG, Yongkang (CN); Huifei HUANG, Yongkang (CN)

(73) Assignees: ZHEJIANG SAFUN INDUSTRIAL CO., LTD., Yongkang (CN); ZHEJIANG KUOCHUANG TECHNOLOGY CO., LTD, Yongkang (CN)

(21) Appl. No.: 19/401,340

(22) Filed: Nov. 25, 2025

Related U.S. Application Data
(63) Continuation-in-part of application No. PCT/CN2025/090814, filed on Apr. 24, 2025.

(30) Foreign Application Priority Data
Jul. 3, 2024 (CN) 202410883746.5

(51) Int. Cl. G05D 1/622; A01D 34/00; A01D 101/00; G05D 1/24; G05D 1/606; G05D 1/65; G05D 101/15; G05D 107/20; G05D 109/10; G05D 111/10; G06V 10/26; G06V 10/60; G06V 10/70; G06V 20/58

(52) U.S. Cl. CPC G05D 1/622; A01D 34/008; G05D 1/24; G05D 1/606; G05D 1/65; G06V 10/26; G06V 10/60; G06V 10/70; G06V 20/58; A01D 2101/00; G05D 2101/15; G05D 2107/23; G05D 2109/10; G05D 2111/10

(57) ABSTRACT

Provided is a method for adaptive mowing control of a mowing robot, the method relates to the technical field of the mowing robot. The method includes: performing block segmentation on a real-time operation environment image into a near-field environment image portion and a far-field environment image portion based on an operation travel speed of a mowing robot and using an effective imaging distance as a segmentation parameter, wherein a maximum operation travel speed is positively proportional to an area proportion of the near-field environment image portion in the real-time operation environment image. The area proportion does not exceed 25%, and the area proportion is related to ambient light intensity. By dividing the real-time operation environment image into the near-field and the far-field environment image portions, the method reduces computing power consumption in processing the real-time operation environment image.

### CROSS-REFERENCE TO RELATED APPLICATIONS

This application is a Continuation-in-part of International Application No. PCT/CN2025/090814, filed on Apr. 24, 2025, which claims priority to Chinese Patent Application No. 202410883746.5, filed on Jul. 3, 2024, the entire contents of each of which are hereby incorporated by reference.

### TECHNICAL FIELD

The present disclosure relates to the field of mowing robot technology, and in particular to a method for adaptive mowing control of a mowing robot.

### BACKGROUND

With the rapid development of the industrial economy, environmental governance faces greater challenges. To a large extent, increasing global green coverage is one of the effective measures for current environmental governance. Maintenance and care of lawns require substantial investment of manpower and material resources. How to improve the efficiency of green lawn maintenance management and reduce the labor intensity of relevant personnel is an urgent problem to be solved. Manual mowing is a monotonous and time-consuming task, and the workers also face threats from lawn slopes, obstacles, gravel, and even harmful insects in the grass. The emergence of mowing robots has solved these problems.

Current mowing robots mainly rely on traditional measures such as contact sensors and wire guidance technology for a control system for obstacle avoidance, which is inefficient and prone to damaging obstacles. Due to the inherent shortcomings of sensors, they often fail to perceive environmental information comprehensively and sufficiently in actual working environments, and the sensors are prone to false detections and missed detections. With the rapid development of deep learning in recent years, object detection technology based on deep learning can enable mowing robots to identify obstacles more intelligently and effectively. By detecting the obstacle type, a relevant obstacle avoidance strategy can be formulated.

Existing mowing robots have poor obstacle avoidance efficiency and trajectory control accuracy during operation, resulting in significant time waste when performing large-scale mowing tasks. Furthermore, the mowing robots are susceptible to interference from the ambient lighting environment when avoiding obstacles, leading to low obstacle recognition accuracy. Therefore, it is desired to provide a method for adaptive mowing control of a mowing robot.

### SUMMARY

An objective of the present disclosure is to provide a method for adaptive mowing control of a mowing robot, which solves the problems of poor obstacle avoidance efficiency and low path control accuracy in existing lawn mowing robots during operation. These shortcomings result in significant time wastage when performing large-scale mowing tasks. Additionally, the robot is susceptible to interference from external lighting conditions while avoiding obstacles, leading to low obstacle recognition accuracy.

To solve the above technical problems, one or more embodiments of the present disclosure provide a method for adaptive mowing control of a mowing robot. The method may include the following steps:

S1, acquiring a real-time operation environment image and trajectory motion information of the mowing robot.

S2, adaptively controlling an effective imaging distance for the mowing robot to capture the real-time operation environment image based on an ambient lighting environment during a current mowing operation, the adaptive control of the effective imaging distance of the real-time operation environment image in step S2 includes: configuring a photosensitive sensor disposed on the mowing robot to acquire forward light intensity information during the current mowing operation, comparing current light intensity information with a standard light intensity range to identify standard light intensity information having a same light intensity within the standard light intensity range, and adaptively controlling the effective imaging distance for the mowing robot to capture the real-time operation environment image based on distance data corresponding to the standard light intensity information; in response to the current light intensity information being lower than a lowest threshold value of the standard light intensity range, stopping acquiring the real-time operation environment image of the mowing robot and stopping the mowing operation; in response to the current light intensity information being higher than a highest threshold value of the standard light intensity range, controlling the effective imaging distance for the mowing robot to capture the real-time operation environment image based on distance data corresponding to the highest threshold value of the standard light intensity range.

S3, performing block segmentation on the real-time operation environment image into a near-field environment image portion and a far-field environment image portion based on an operation travel speed of the mowing robot and using the effective imaging distance as a segmentation parameter. The near-field environment image portion is an image radiating outward from the mowing robot as a center and not exceeding one quarter of an area of the real-time operation environment image, and the far-field environment image portion includes all portions of the real-time operation environment image excluding the near-field environment image portion. A maximum operation travel speed is positively proportional to an area proportion of the near-field environment image portion in the real-time operation environment image, and the area proportion of the near-field environment image portion in the real-time operation environment image does not exceed 25%. The area proportion of the near-field environment image portion is related to ambient light intensity, and the higher the ambient light intensity is, the larger the area proportion of the near-field environment image portion is.

S4, processing and analyzing the real-time operation environment image by using an image processing technique to identify and determine an obstacle.

S5, when the obstacle is identified in the real-time operation environment image, obtaining an obstacle type and simultaneously obtaining an obstacle avoidance range corresponding to the obstacle type.

S6, controlling the mowing robot to perform proactive obstacle avoidance based on the obstacle avoidance range.

The acquisition of the real-time operation environment image and the trajectory motion information of the mowing robot is accomplished by a camera and a position sensor, respectively. The camera is configured to acquire a fan-shaped image area in front of the mowing robot during the mowing operation, send the acquired image information to a trained Support Vector Machine (SVM) model for image recognition and classification, and identify the obstacle type of the obstacle in front of the mowing robot during the mowing operation and obtain a bounding box and confidence information. The position sensor is configured to acquire real-time position data of the mowing robot, so as to plan a travel path.

The effective imaging distance is positively proportional to the forward light intensity information during the mowing operation; the higher the current light intensity information is, the longer the effective imaging distance is. Conversely, the lower the current light intensity information is, the shorter the effective imaging distance is. The operation travel speed of the mowing robot is limited by the effective imaging distance of the mowing robot. When performing the mowing operation to meet mowing standards, the mowing robot adaptively controls the operation travel speed. The operation travel speed is limited by the imaging distance of the real-time operation environment image; the longer the effective imaging distance is, the higher the maximum operation travel speed of the mowing robot is. When the effective imaging distance reaches a critical distance, the maximum operation travel speed of the mowing robot is set to a highest allowable limit.

A control system for controlling operation of the mowing robot is provided inside the mowing robot, and the adaptive control of the mowing robot is completed through the control system. Before processing and analyzing the real-time operation environment image in step S4, processing weight allocation is performed on the real-time operation environment image, the processing weight allocation including: performing weight allocation based on the area proportion of the near-field environment image portion and an area proportion of the far-field environment image portion in the real-time operation environment image, the higher the area proportion of an image is, the higher a processing weight allocated to the image is, and the more system resources are allocated when processing the image; a sum of a processing weight of the near-field environment image portion and a processing weight of the far-field environment image portion is equal to 1.

The control system processes the near-field environment image portion and the far-field environment image portion simultaneously.

### BRIEF DESCRIPTION OF THE DRAWINGS

To more clearly illustrate the technical solutions in the embodiments of the present disclosure, the following briefly introduces the drawings required for describing the embodiments. Obviously, the drawings in the following description are only some embodiments of the present disclosure. For those of ordinary skill in the art, other drawings may be obtained based on these drawings without creative effort.

FIG. 1 is a flowchart illustrating an exemplary process of a method for adaptive mowing control of a mowing robot according to some embodiments of the present disclosure.

FIG. 2 is a flowchart illustrating a process for processing a real-time operation environment image according to some embodiments of the present disclosure.

FIG. 3 is a flowchart illustrating a process for re-determining an effective imaging distance according to some embodiments of the present disclosure.

### DETAILED DESCRIPTION

To make the technical solutions, creative features, objectives, and effects achieved by the present disclosure easy to understand, the present disclosure is further described below in conjunction with the detailed description.

In the description of the present disclosure, it should be noted that the orientation or positional relationships indicated by the terms “upper,” “lower,” “inner,” “outer,” “front end,” “rear end,” “two ends,” “one end,” “another end,” etc., are based on the orientation or positional relationships shown in the drawings, and are only for the convenience of describing the present disclosure and simplifying the description, rather than indicating or implying that the referred device or element must have a specific orientation, be constructed and operated in a specific orientation, and therefore should not be construed as limiting the present disclosure. Furthermore, the terms “first” and “second” are used for descriptive purposes only and should not be construed as indicating or implying relative importance.

In the description of the present disclosure, it should be noted that, unless otherwise explicitly specified and defined, the terms “install,” “provided with,” “connect,” etc., should be understood broadly. For example, “connect” may be a fixed connection, a detachable connection, or an integral connection. It may be a mechanical connection, an electrical connection, or a direct connection. It may be connected directly, or indirectly through an intermediate medium, or it may be the internal communication between two elements. For those of ordinary skill in the art, the specific meanings of the above terms in the present disclosure can be understood according to specific situations.

In some embodiments, a control system for controlling an operation of a mowing robot is provided inside the mowing robot. The control system is configured to execute a method for adaptive mowing control of a mowing robot.

In some embodiments, the control system may include a processor, a storage device, etc. The processor may be configured to process data from at least one component of the mowing robot or an external data source. The processor may include a central processing unit (CPU), an application-specific integrated circuit (ASIC), an application-specific instruction set processor (ASIP), a graphics processing unit (GPU), a physics processing unit (PPU), a digital signal processor (DSP), a controller, a microcontroller unit, a microprocessor, or the like, or any combination thereof.

The storage device may be configured to store data, instructions, and/or any other information. In some embodiments, the storage device may store data and/or instructions used by the processor to execute or use to complete the exemplary methods described in the present disclosure. The storage device may include a mass storage, a removable storage, or the like, or any combination thereof.

In some embodiments, the mowing robot may further include a battery system, a mobility system, a cutting system, etc. The mobility system may include a steering wheel, a drive motor, a rotating chassis, etc. The cutting system may include a cutting blade, a cutting motor, etc.

In some embodiments, the mowing robot and components (e.g., a camera, a position sensor, and a photosensitive sensor, etc.) on the mowing robot may be communicatively connected to the control system.

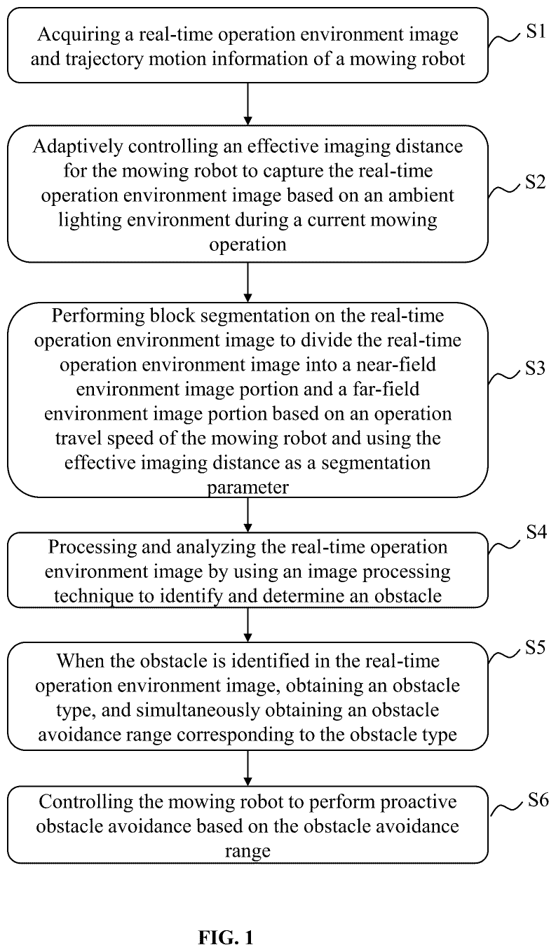

FIG. 1 is a flowchart illustrating an exemplary process of a method for adaptive mowing control of a mowing robot according to the present disclosure.

In some embodiments, referring to FIG. 1, the method for adaptive mowing control of the mowing robot includes the following steps:

S1, acquiring a real-time operation environment image and trajectory motion information of the mowing robot.

The real-time operation environment image may be an image related to an environment in which the mowing robot is located, collected in real time during a mowing operation of the mowing robot. The trajectory motion information may be information related to a travel path of the mowing robot. In some embodiments, the trajectory motion information may include a travel direction, a travel speed, or the like of the mowing robot.

In some embodiments, the acquisition of the real-time operation environment image and the trajectory motion information of the mowing robot is accomplished by a camera and a position sensor deployed in the mowing robot, respectively.

The camera is configured to acquire a fan-shaped image area (i.e., the real-time operation environment image) in front of the mowing robot during the mowing operation, send the acquired image information to a trained Support Vector Machine (SVM) model for image recognition and classification, and identify an obstacle type of an obstacle in front of the mowing robot during the mowing operation and obtain a bounding box and confidence information. The SVM model may be built into the processor.

The real-time operation environment image may be an image whose area is the same as an area of a fan shape with a certain radius.

In some embodiments, the obstacle type may include a tree, a ditch, a human, an animal, etc.

The bounding box refers to a border in the real-time operation environment image used to frame the obstacle. The confidence information may represent a reliability degree of the obstacle type identified by the SVM model.

In some embodiments, the processor in the control system may train the SVM model using gradient descent or similar techniques, based on a large number of training samples with labels. The training samples may include sample images, and the labels of the training samples may be obstacle types and confidence information of obstacles in the sample images. A sample image may be an image containing an obstacle.

In some embodiments, the training samples may be obtained based on historical data, and the labels may be determined based on manual annotation.

In some embodiments, the SVM model may be trained in the following manner: inputting a plurality of training samples with labels into an initial SVM model, constructing a loss function based on the labels and prediction results of the initial SVM model, iteratively updating the initial SVM model based on the loss function, and completing the training of the SVM model when the loss function of the initial SVM model satisfies a preset condition. The preset condition may be convergence of the loss function, a count of iterations reaching a set value, etc.

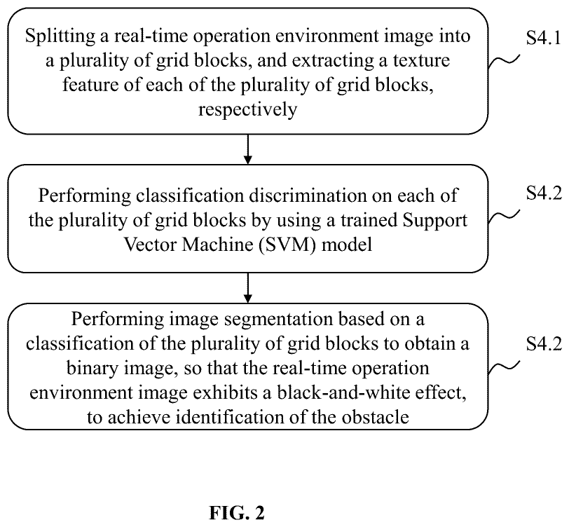

In some embodiments, the SVM model may also be trained using a dataset including lawn texture features and obstacle texture features. More descriptions regarding the embodiment herein may be found in FIG. 2 and its related descriptions.

The position sensor is configured to acquire real-time position data of the mowing robot, so as to plan the travel path.

In some embodiments, the position sensor may send the real-time position data to the control system. The control system may automatically set the travel direction and the travel speed (i.e., the trajectory motion information) of the mowing robot based on the real-time position data, so as to enable the mowing robot to complete the mowing operation.

S2, adaptively controlling an effective imaging distance for the mowing robot to capture the real-time operation environment image based on an ambient lighting environment during a current mowing operation.

The effective imaging distance may be a radius of a fan-shaped image captured by the camera, etc.

In some embodiments, a photosensitive sensor disposed on the mowing robot is configured to acquire forward light intensity information (also referred to as an ambient light intensity) during the current mowing operation. If current light intensity information (also referred to as the forward light intensity information during the current mowing operation) is within a standard light intensity range, the control system compares the current light intensity information with the standard light intensity range to identify standard light intensity information having a same light intensity within the standard light intensity range, and adaptively controls the effective imaging distance for the mowing robot to capture the real-time operation environment image based on distance data corresponding to the standard light intensity information.

The standard light intensity information refers to a preset light intensity. In some embodiments, the standard light intensity information and the distance data corresponding to the standard light intensity information may be preset based on historical experience.

The standard light intensity range refers to a range composed of a plurality of standard light intensities. In some embodiments, in response to the current light intensity information being lower than a lowest threshold value of the standard light intensity range (i.e., the standard light intensity information with the lowest numerical value within the standard light intensity range), the control system controls the mowing robot to stop acquiring the real-time operation environment image and stop the mowing operation. In response to the current light intensity information being higher than a highest threshold value of the standard light intensity range (i.e., the standard light intensity information with the highest numerical value within the standard light intensity range), the control system controls the effective imaging distance for the mowing robot to capture the real-time operation environment image based on the distance data corresponding to the highest threshold value of the standard light intensity range.

In some embodiments, the effective imaging distance may be positively proportional to the forward light intensity information during the mowing operation, the higher the current light intensity information is, the longer the effective imaging distance is. Conversely, the lower the current light intensity information is, the shorter the effective imaging distance is.

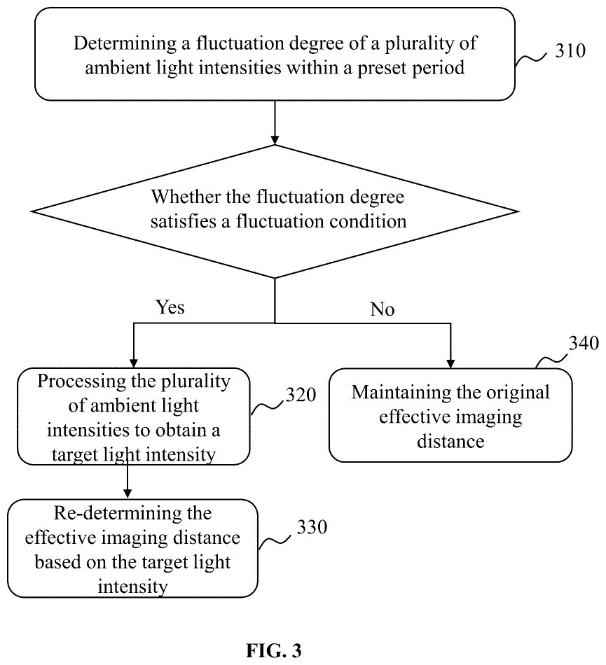

In some embodiments, the control system may process a plurality of ambient light intensities to obtain a target light intensity, and re-determine the effective imaging distance based on the target light intensity. More descriptions regarding the embodiment herein may be found in FIG. 3 and its related descriptions.

In some embodiments, the control system may limit an operation travel speed of the mowing robot based on the effective imaging distance of the mowing robot. The operation travel speed refers to a travel speed of the mowing robot during the mowing operation.

In some embodiments, when the mowing robot performs the mowing operation to meet mowing standards, the control system adaptively controls the operation travel speed. The longer the effective imaging distance is, the higher a maximum operation travel speed of the mowing robot (i.e., the higher a set value of the maximum operation travel speed) is. When the effective imaging distance reaches a critical distance (i.e., a maximum value of the effective imaging distance), the maximum operation travel speed of the mowing robot is set to a highest allowable limit (i.e., the set value of the maximum operation travel speed is equal to a maximum travel speed achievable by the mowing robot).

In some embodiments, the control system may determine a light intensity trend based on historical light intensities. In response to the light intensity trend being a weakening trend, the control system may shorten the effective imaging distance and reduce the maximum operation travel speed.

The historical light intensities refer to a collection of ambient light intensities continuously collected within a preset historical period. In some embodiments, the historical light intensities may be a collection of ambient light intensities continuously collected by a photosensitive sensor within the preset historical period.

The preset historical period may be predefined. The duration of the preset historical period is greater than the duration of a preset period.

The light intensity trend refers to a change direction of ambient light intensities within a future time period. In some embodiments, the light intensity trend may include a weakening trend, a strengthening trend, a stabilizing trend, etc.

In some embodiments, the control system may determine the light intensity trend based on historical light intensity information using a trend analysis algorithm (e.g., calculating moving averages, fitting trend lines, etc.). For example, the control system represents the light intensity trend by fitting a trend line.

In some embodiments, in response to the light intensity trend being a weakening trend, the control system may shorten the effective imaging distance based on a first adjustment magnitude and reduce the maximum operation travel speed based on a second adjustment magnitude. The first adjustment magnitude and the second adjustment magnitude may be preset based on historical experience.

In some embodiments, in response to the light intensity trend being a strengthening trend or a stabilizing trend, the control system may maintain the existing effective imaging distance and the maximum operation travel speed.

In some embodiments of the present disclosure, by predicting the light intensity trend and making gradual adjustments in advance, perception and motion control of the mowing robot can safely and progressively adapt to changes in ambient lighting conditions, thereby effectively avoiding sudden degradation of the operational performance of the mowing robot caused by abrupt changes in lighting conditions and ensuring stability and continuity of the mowing operation.

In some embodiments, the control system determines, based on the light intensity trend, a remaining battery level of the mowing robot, and the trajectory motion information, whether the mowing robot is able to complete the mowing operation and return for charging before the ambient light intensity satisfies a lighting condition. More descriptions regarding the trajectory motion information may be found in FIG. 1 and its related descriptions. The control system may obtain the remaining battery level from a battery system of the mowing robot.

In response to determining that the mowing robot is unable to complete the mowing operation and return for charging before the ambient light intensity satisfies the lighting condition, the control system controls the mowing robot to return in advance.

In response to determining that the mowing robot is able to complete the mowing operation and return for charging before the ambient light intensity satisfies the lighting condition, the control system controls the mowing robot to continue performing the mowing operation.

In some embodiments, the lighting condition may include the ambient light intensity being less than the lowest threshold value of the standard light intensity range. In response to the light intensity trend being the weakening trend, the control system may select a coordinate point on the fitted trend line where the ambient light intensity is less than the lowest threshold value of the standard light intensity range, and record a time point corresponding to the coordinate point as a critical time point.

In some embodiments, the control system may determine a duration and a battery level required for the mowing robot to complete the mowing operation, and a duration and a battery level required for the mowing robot to return to a charging station after completing the mowing operation, based on the mowing robot's own energy consumption and a position, a speed, a direction, etc., of the mowing robot in the trajectory motion information. The calculated duration and battery level are recorded as a target duration and a target battery level, respectively. The energy consumption of the mowing robot may be determined based on factory parameters or historical usage records of the mowing robot, including power consumption per unit time (e.g., 10 seconds) and power consumption per unit distance (e.g., 1 meter) traveled, or the like, during the mowing operation.

In some embodiments, in response to determining that the remaining battery level of the mowing robot is greater than a sum of the target battery level and a reserved battery level, and a sum of a current time and the target duration does not exceed the critical time point, the control system determines that the mowing robot is able to complete the mowing operation and return for charging before the ambient light intensity satisfies the lighting condition (e.g., the ambient light intensity being less than the lowest threshold value of the standard light intensity range).

The reserved battery level may be a fixed battery level retained in the mowing robot. The reserved battery level may prevent the mowing robot from running out of power due to unexpected situations.

In some embodiments, in response to determining that the remaining battery level of the mowing robot is not greater than the sum of the target battery level and the reserved battery level, or the sum of the current time and the target duration exceeds the critical time point, the control system determines that the mowing robot is unable to complete the mowing operation and return for charging before the ambient light intensity satisfies the lighting condition.

In some embodiments, in response to determining that the mowing robot is unable to complete the mowing operation and return for charging before the ambient light intensity satisfies the lighting condition, the control system controls the mowing robot to return at the current time.

In some embodiments, the control system may determine a difference between the remaining battery level and the battery level required for the mowing robot to return to the charging station after completing the mowing operation, and determine a duration for which the mowing robot is able to continue to operate based on the difference and the energy consumption of the mowing robot.

In some embodiments of the present disclosure, if the mowing robot is not able to complete the mowing operation and return safely before the ambient light intensity satisfies the lighting condition, a return process of the mowing robot can be initiated in advance, thereby improving the reliability and automation level of the mowing operation of the mowing robot.

S3, performing block segmentation on the real-time operation environment image to divide the real-time operation environment image into a near-field environment image portion and a far-field environment image portion based on an operation travel speed of the mowing robot and using the effective imaging distance as a segmentation parameter.

The near-field environment image portion may be a portion of the real-time operation environment image, centered on the mowing robot, radiating outward and not exceeding one quarter of a total area of the real-time operation environment image. The far-field environment image portion may include all portions of the real-time operation environment image excluding the near-field environment image portion.

In some embodiments, since the real-time operation environment image is a fan-shaped image, the control system may divide the effective imaging distance into two segments. A segment (a first segment) close to the mowing robot serves as a radius of the near-field environment image portion, and a segment (a second segment) far from the mowing robot serves as a radius of the far-field environment image portion. The ratio of the first segment to the second segment is related to the operation travel speed of the mowing robot. The faster the operation travel speed, the greater the ratio of the first segment to the second segment. The ratio of the first segment to the second segment does not exceed 33%.

In some embodiments, the maximum operation travel speed may be positively proportional to an area proportion of the near-field environment image portion in the real-time operation environment image, and the area proportion of the near-field environment image portion is related to the ambient light intensity. The higher the ambient light intensity is, the larger the area proportion of the near-field environment image portion is. The area proportion of the near-field environment image portion in the real-time operation environment image does not exceed 25%.

S4, processing and analyzing the real-time operation environment image by using an image processing technique to identify and determine an obstacle.

In some embodiments, the control system may process and analyze the real-time operation environment image by using the SVM model to identify the obstacle in the real-time operation environment image. More descriptions regarding the embodiment herein may be found in step S1 in FIG. 1 and the related descriptions.

In some embodiments, the control system may perform classification discrimination on each of a plurality of grid blocks by using the trained Support Vector Machine (SVM) model, and perform image segmentation based on the classification of the plurality of grid block to obtain a binary image, so that the real-time operation environment image exhibits a black-and-white effect, to achieve identification of the obstacle. More descriptions regarding the embodiments herein may be found in FIG. 2 and its related descriptions.

In some embodiments, before processing and analyzing the real-time operation environment image, the control system may perform processing weight allocation on the real-time operation environment image, that is, allocate a processing weight of the near-field environment image portion and a processing weight of the far-field environment image portion.

In some embodiments, the control system performs weight allocation based on the area proportion of the near-field environment image portion and the area proportion of the far-field environment image portion in the real-time operation environment image, the higher the proportion of an image portion is, the higher a processing weight allocated to the image portion is, and the more system resources are allocated when processing the image portion, a sum of the processing weight of the near-field environment image portion and the processing weight of the far-field environment image portion is equal to 1. The system resources may include a CPU usage rate, a disk space, a network bandwidth, etc.

In some embodiments, the control system may process the near-field environment image portion and the far-field environment image portion simultaneously.

S5, when the obstacle is identified in the real-time operation environment image, obtaining an obstacle type of the obstacle and simultaneously obtaining an obstacle avoidance range corresponding to the obstacle type.

The obstacle avoidance range may be a safe distance between the mowing robot and the obstacle. When a distance between the mowing robot and the obstacle is less than the obstacle avoidance range, the mowing robot may contact or collide with the obstacle.

In some embodiments, when an obstacle is identified in the real-time operation environment image by using the SVM model, the control system may acquire the obstacle type of the obstacle by using the SVM model, and acquire the obstacle avoidance range corresponding to the obstacle type by querying a preset table.

In some embodiments, the preset table may be pre-constructed based on historical experience. The preset table includes a plurality of obstacle types and obstacle avoidance ranges corresponding to the obstacle types, respectively.

In some embodiments, the obstacle avoidance range of the mowing robot exceeds an obstacle range by at least 10%. The obstacle range for an obstacle type may be a range in which the obstacle type may affect the mowing robot. The obstacle ranges corresponding to different obstacle types may be preset based on historical experience.

By way of example, suppose the obstacle is a fire hydrant, the radius of the fire hydrant is 0.1 meter, and the obstacle range of the fire hydrant is 0.2 meter. In this case, the obstacle avoidance range of the mowing robot is at least 0.22 meter.

S6, controlling the mowing robot to perform proactive obstacle avoidance based on the obstacle avoidance range.

In some embodiments, the control system may control the travel direction and the travel speed of the mowing robot based on the obstacle avoidance range, so that the mowing robot bypasses the obstacle (i.e., maintains the distance between the mowing robot and the obstacle not less than the obstacle avoidance range) or stops in place.

FIG. 2 is a flowchart illustrating a process of processing a real-time operation environment image according to the present disclosure.

In some embodiments, the processing and analyzing the real-time operation environment image by using the image processing technique by the control system includes the following operations:

S4.1, splitting the real-time operation environment image into a plurality of grid blocks, and extracting a texture feature of each of the plurality of grid blocks, respectively.

In some embodiments, the control system splits the real-time operation environment image into the plurality of grid blocks based on a preset grid block size.

The texture feature of a grid block may characterize a variation pattern of pixel gray values in the grid block. In some embodiments, the texture feature may be represented by statistics such as energy, entropy, contrast, inverse difference moment, or the like.

In some embodiments, the control system may extract the texture feature of each of the plurality of grid blocks by using a gray-level co-occurrence matrix (GLCM) feature extraction technique. The GLCM feature extraction technique includes:

The control system sets two gray levels to i and j, wherein a direction and a step length in an image plane for pixel pairs corresponding to the two gray levels are set as θ and d, respectively, and the control system sets f(x, y) to represent a real-time environment image of a size M×N with a count of gray levels L, then elements of a gray-level co-occurrence matrix (L×L) for the real-time environment image are shown in Equation (1):

$$p ( i , j , d , θ ) = \# \{ ( {x}_{1} , {y}_{1} ) , ( {x}_{2} , {y}_{2} ) \} ∈ M \times N \vert f ( {x}_{1} , {y}_{1} ) = i , f ( {x}_{2} , {y}_{2} ) = j . \qquad ( 1 )$$

In Equation (1), #{x} denotes solving for a count of x elements in the set, 0≤i, j≤L⁻¹, (x₁, y₁), (x₂, y₂) denotes a pixel pair consisting of two pixel points, (x₁, y₁) denotes a coordinate of a first pixel, and (x₂, y₂) denotes a coordinate of a second pixel. M denotes a row count of the image, N denotes a column count of the image, and M×N represents a set of all pixel coordinates in a real-time environment image. f(x₁, y₁)=i denotes that a gray value of a pixel at coordinate (x₁, y₁) is equal to i, and f(x₂, y₂)=j denotes that a gray value of a pixel at coordinate (x₂, y₂) is equal to j. p (i, j, d, θ) is used to calculate a count of pixel pairs that satisfy the following pixel pair condition in the real-time environment image (M×N): a gray value of the first pixel is i, a gray value of the second pixel is j, the second pixel is located in the θ direction of the first pixel, and is separated by d pixels.

In some embodiments, the GLCM is unable to directly reflect the texture feature of the image, however, texture feature may be extracted from the GLCM through various second-order statistics. The GLCM includes more than ten statistical measures such as energy, entropy, contrast, inverse difference moment, homogeneity, correlation, variance, sum average, sum variance, sum entropy, difference variance, difference average, difference entropy, information measure of correlation, and maximal correlation coefficient. The energy (Angular Second Moment, ASM) may represent uniformity of gray distribution and coarseness of a texture. The entropy (ENT) may represent complexity of an image texture, and has a larger value when the image texture includes elements with relatively high randomness. The contrast (CON) represents a depth of the image texture. The inverse Difference Moment (IDM) represents a degree of local variation of the texture. The present disclosure uses four statistical measures to analyze and process features of the real-time operation environment image. The calculation equations are as follows:

$$ENT = - {\sum }_{i = 1}^{L} {\sum }_{j = 1}^{L} G ( i , j ) log G ( i , j ) , \qquad ( 2 )$$

$$CON = {\sum }_{n = 0}^{L - 1} {n}^{2} \vert {\sum }_{\vert i - j \vert - n} G ( i , j ) \vert , \qquad ( 3 )$$

$$A S M = {\sum }_{i = 1}^{L} {\sum }_{j = 1}^{L} {( G ( i , j ) )}^{2} , \qquad ( 4 )$$

$$I D M = - {\sum }_{i = 1}^{L} {\sum }_{j = 1}^{L} \frac{G ( i , j )}{1 + {( i - j )}^{2}} . \qquad ( 5 )$$

In the above equations, G(i, j) is a probability of occurrence of a pixel pair satisfying the pixel pair condition in a normalized GLCM.

In some embodiments, when the control system determines the texture feature by using the GLCM, the larger the count of gray levels is, the larger a count of statistically obtained texture features is. Therefore, gray level reduction processing is performed on the real-time operation environment image, and the count of gray levels L and the step size d of the gray-level co-occurrence matrix are determined by establishing an experimental model, including the following operations:
(1). Randomly selecting 10 sample image blocks from a plurality of lawn images and a plurality of images containing an obstacle. By changing the count of gray levels of the ten sample image blocks, three sample image databases when the count of gray levels L are set to 8, 16, and 32, respectively, are obtained.
(2). Extracting effective texture features (i.e., the energy, the entropy, the contrast, and the inverse difference moment) from each of the sample image blocks in each of the sample image databases, and obtaining a set of 16 features (4 directions×4 texture features) for each of the sample image blocks in each of the sample image databases by computing the effective texture features from directions 0°, 45°, 90°, and 135°.
(3). Sequentially setting the count of gray levels L to 8, 16, and 32, incrementally changing the step size d within a range of [0,15], determining a mean value of texture features of the lawn and a mean value of texture features of the obstacle under each of a plurality of combinations of L and d through statistical calculation, and determining a difference between the two mean values; determining the difference between the mean value of the texture features of the lawn and the mean value of the texture features of the obstacle based on each of different counts of gray levels and statistical step sizes.

The mean value of the texture features of the lawn may be a mean value of the texture features of sample image blocks containing lawn images. The texture features of the obstacle may be mean values of the texture features of sample image blocks containing obstacle images. The mean value of the texture features may be a normalized mean value of the 16 texture features corresponding to the sample image blocks.
(4). For each of the counts of gray levels of 8, 16, and 32, plotting a curve representing an average difference (also referred to as a difference between mean values) between the texture features of the lawn and the texture features of the obstacle, resulting in three curves, and selecting, from the three curves, a parameter combination that results in a greatest distinction between the texture features of the lawn and the texture features of the obstacle.

Exemplarily, the three curves correspond to the counts of gray levels of 8, 16, and 32, respectively. In each of the three curves, the horizontal coordinate represents the step size, and the vertical coordinate represents the difference between the mean value of the texture features of the lawn and the mean value of the texture features of the obstacle. A point with a largest vertical coordinate value among the three curves is identified as a target point, and a curve where the target point is located is designated as a target curve. The control system combines a count of gray levels of the target curve and a horizontal coordinate of the target point as a parameter combination with a greatest distinction between the texture features of the lawn and the texture features of the obstacle.

Through statistical calculation, the count of gray levels and the step size are selected as 16 and 1, respectively (i.e., in the parameter combination with the greatest distinction, the count of gray levels is 16, and the step size is 1). The above example where the count of gray levels and the step size are 16 and 1, respectively, is merely for illustration. In practical applications, the count of gray levels and the step size of the gray-level co-occurrence matrix (GLCM) determined by establishing the experimental model may be different. For example, the count of gray levels is 16, and the step size is 2. As another example, the count of gray levels is 8, and the step size is 1. As still another example, the count of gray levels is 32, and the step size is 2.

S4.2, performing classification discrimination on each of the plurality of grid blocks by using the trained SVM model.

In some embodiments, the SVM model may perform the classification discrimination on each of the plurality of grid blocks, divide the plurality of grid blocks into grid blocks representing obstacles and grid blocks representing non-obstacles, and identify them with numerical values. For example, a numerical value of 1 identifies a grid block representing an obstacle, and a numerical value of 0 identifies a grid block representing a non-obstacle.

In some embodiments, the GLCM is highly sensitive to an image texture direction. When performing GLCM calculation. Therefore, the directions used in the calculation must be strictly defined. The present disclosure selects 0°, 45°, 90°, and 135° for scanning and computation. A dataset containing the texture features of the lawn and the texture features of the obstacle is constructed to train an SVM model.

In some embodiments, the construction of the dataset includes: using the plurality of lawn images and the plurality of images containing obstacles, 16-dimentional data is formed based on the combinations of the four directions (0°, 45°, 90°, and) 135° and the four statistical measures (energy, entropy, contrast, and inverse difference moment), the 16-dimensional data is simultaneously normalized to a preset range to obtain a plurality of training samples and a plurality of test samples. The control system uses the plurality of training samples to perform classification training on the SVM model. The control system uses the plurality of test samples to test the SVM model after the classification training, and adjusts parameters of the SVM model based on a test result to obtain the trained SVM model.

S4.3, performing image segmentation based on the classification of each of the plurality of grid blocks to obtain a binary image, so that the real-time operation environment image exhibits a black-and-white effect, to achieve identification of the obstacle.

In some embodiments, the control system, based on the classification of each of the plurality of grid blocks, renders blocks with a value of 1 in white (or black) and blocks with a value of 0 in black (or white), thereby generating the binary image that presents the real-time working environment in the black-and-white effect. In the resulting image, white areas represent obstacles, while black areas represent non-obstacles.

In some embodiments, when the mowing robot travels according to an initial path and detects that an obstacle exists on the initial path, the control system may determine whether the mowing robot is able to travel within a valid region corresponding to the initial path and bypass the obstacle. The valid region corresponding to the initial path may be a region formed by expanding outward within a range of 180° to a left side and a right side in front of a trajectory direction of the mowing robot, with a position of the mowing robot along the initial path as a center. The initial path may be preset based on historical experience.

In some embodiments, in response to determining that the mowing robot is able to bypass the obstacle, the control system controls the mowing robot to bypass the obstacle and travel within the valid region corresponding to the initial path.

In some embodiments, in response to determining that the mowing robot is not able to bypass the obstacle when travelling within the valid region, the control system re-plans a new path, and controls the mowing robot to bypass the obstacle and travel on the new path. The new path may be obtained by input from a technician, or may be automatically set by the control system, etc. For example, the control system may control the mowing robot to reverse a first preset distance along the initial path, move a second preset distance to the left or right, and then advance from the new position to an end point of the initial path. A path between the new position and the end point of the initial path is designated as the new path. The first preset distance and the second preset distance may be pre-determined.

The working principle of the present disclosure is as follows: the effective imaging distance for capturing the real-time operation environment image is controlled based on a light intensity of a real-time operation environment of the mowing robot, the stronger an ambient light is, the longer the effective imaging distance of the real-time operation environment image is. The dimmer the ambient light is, the shorter the effective imaging distance of the real-time operation environment image is. Stronger ambient light means that the captured real-time operation environment image is clearer, and the control system has more discrimination when identifying obstacles, making it easier for the control system to identify obstacles, thus allowing for a longer effective imaging distance. Dimmer ambient light means that the captured real-time operation environment image is blurrier, increasing the difficulty and computational load for obstacle recognition, which requires shortening the effective imaging distance. The setting of the effective imaging distance may be directly reflected in the captured content of the real-time operation environment image. The less the captured content of the real-time operation environment image is, the easier it is to process the image, and the more the content of the real-time operation environment image is, the more difficult it is to process the image. This approach alleviates computing power consumption for adaptive control of the mowing robot and improves operation safety of the mowing robot.

The present disclosure couples the operation travel speed of the mowing robot to the effective imaging distance of the mowing robot, and adaptively controls the operation travel speed based on the mowing robot performing the mowing operation to ensure standard mowing performance is maintained. The longer the effective imaging distance is, the higher the area proportion of the near-field environment image portion in the real-time operation environment image is, and the higher the maximum operation travel speed is. The shorter the effective imaging distance is, the lower the area proportion of the near-field environment image portion in the real-time operation environment image, and the lower the maximum operation travel speed. This approach ensures operational safety while improving work efficiency.

The present disclosure divides the real-time operation environment image into the near-field environment image portion and the far-field environment image portion, which can reduce the computing power required for processing the real-time operation environment image.

FIG. 3 is a flowchart illustrating a process for re-determining an effective imaging distance according to some embodiments of the present disclosure.

In 310, determining a fluctuation degree of a plurality of ambient light intensities within a preset period.

The preset period may be pre-determined based on historical experience, such as 5s, 10s, etc.

More descriptions regarding the ambient light intensity and the effective imaging distance may be found in FIG. 1 and its related descriptions.

In some embodiments, the fluctuation degree of the plurality of ambient light intensities may be represented by a variance or a standard deviation of the plurality of ambient light intensities. A fluctuation condition may include the fluctuation degree being greater than a preset fluctuation threshold. The preset fluctuation threshold may be pre-determined based on historical experience.

In some embodiments, the control system may determine whether the fluctuation degree satisfies the fluctuation condition. In response to the fluctuation degree satisfying the fluctuation condition, operations 320 and 330 are executed. In response to the fluctuation degree not satisfying the fluctuation condition, operation 340 is performed.

In 320, processing the plurality of ambient light intensities to obtain a target light intensity.

The target light intensity refers to a finally determined ambient light intensity. In some embodiments, the processing performed by the control system on the plurality of ambient light intensities may include smoothing processing, etc. For example, the control system may determine an arithmetic mean of the plurality of ambient light intensities by using a moving average filtering algorithm, etc., to obtain the target light intensity.

Exemplarily, the control system may maintain a first-in-first-out data buffer. The data buffer is used to store a plurality of ambient light intensities within the preset period. When a new ambient light intensity is acquired, the control system adds the new ambient light intensity to the data buffer and removes an ambient light intensity that has been in the data buffer for the longest time from the data buffer. Then, the control system calculates an arithmetic mean of all ambient light intensities in the data buffer as the target light intensity.

In 330, re-determining the effective imaging distance based on the target light intensity.

In some embodiments, the control system may compare the target light intensity with a standard light intensity range to identify standard light intensity information having a same light intensity within the standard light intensity range. The control system re-determines distance data corresponding to the standard light intensity information as the effective imaging distance. More descriptions regarding the standard light intensity range may be found in FIG. 1 and its related descriptions.

In 340, maintaining the original effective imaging distance.

In some embodiments of the present disclosure, by performing smoothing processing on a plurality of ambient light intensities and re-determining the effective imaging distance based on the smoothed light intensities, frequent adjustments of the perception distance and travel speed of the mowing robot caused by short-term fluctuations in lighting are effectively suppressed, thereby enhancing operational stability and ensuring smoother movement during operation.

The present disclosure further includes a method for adaptive mowing control of a mowing robot, the method includes:

S1, acquiring a real-time operation environment image and trajectory motion information of the mowing robot.

S2, adaptively controlling an effective imaging distance for the mowing robot to capture the real-time operation environment image based on an ambient lighting environment during a current mowing operation.

In some embodiments, the adaptive control of the effective imaging distance of the real-time operation environment image in S2 includes: configuring a photosensitive sensor disposed on the mowing robot to acquire forward light intensity information during the current mowing operation, comparing current light intensity information with a standard light intensity range to identify standard light intensity information having a same light intensity within the standard light intensity range. The control system adaptively controls the effective imaging distance for the mowing robot to capture the real-time operation environment image based on distance data corresponding to the standard light intensity information. In response to the current light intensity information being lower than a lowest threshold value of the standard light intensity range, stopping acquiring the real-time operation environment image of the mowing robot and stopping the mowing operation. In response to the current light intensity information being higher than a highest threshold value of the standard light intensity range, controlling the effective imaging distance for the mowing robot to capture the real-time operation environment image based on distance data corresponding to the highest threshold value of the standard light intensity range.

S3, performing block segmentation on the real-time operation environment image to divide the real-time operation environment image into a near-field environment image portion and a far-field environment image portion based on an operation travel speed of the mowing robot and using the effective imaging distance as a segmentation parameter. The near-field environment image portion is an image radiating outward from the mowing robot as a center and not exceeding one quarter of an area of the real-time operation environment image, and the far-field environment image portion includes all portions of the real-time operation environment image excluding the near-field environment image portion. A maximum operation travel speed is positively proportional to an area proportion of the near-field environment image portion in the real-time operation environment image, and the area proportion of the near-field environment image portion in the real-time operation environment image does not exceed 25%. The area proportion of the near-field environment image portion is related to ambient light intensity, and the higher the ambient light intensity is, the larger the area proportion of the near-field environment image portion is.

S4, processing and analyzing the real-time operation environment image by using an image processing technique to identify and determine an obstacle.

S5, when the obstacle is identified in the real-time operation environment image, obtaining an obstacle type of the obstacle and simultaneously obtaining an obstacle avoidance range corresponding to the obstacle type.

S6, controlling the mowing robot to perform proactive obstacle avoidance based on the obstacle avoidance range.

In some embodiments, the acquisition of the real-time operation environment image and the trajectory motion information of the mowing robot is accomplished by a camera and a position sensor, respectively. The camera is configured to acquire a fan-shaped image area in front of the mowing robot during the mowing operation, send the acquired image information to a trained Support Vector Machine (SVM) model for image recognition and classification, and identify the obstacle type of the obstacle in front of the mowing robot during the mowing operation and obtain a bounding box and confidence information. The position sensor is configured to acquire real-time position data of the mowing robot, so as to plan a travel path.

In some embodiments, the effective imaging distance is positively proportional to the forward light intensity information during the mowing operation; the higher the current light intensity information is, the longer the effective imaging distance is. Conversely, the lower the current light intensity information is, the shorter the effective imaging distance is. The operation travel speed of the mowing robot is limited by the effective imaging distance of the mowing robot. When performing the mowing operation to meet mowing standards, the mowing robot adaptively controls the operation travel speed. The operation travel speed is limited by the imaging distance of the real-time operation environment image; the longer the effective imaging distance is, the higher the maximum operation travel speed of the mowing robot is. When the effective imaging distance reaches a critical distance, the maximum operation travel speed of the mowing robot is set to a highest allowable limit.

In some embodiments, a control system for controlling operation of the mowing robot is provided inside the mowing robot, and the adaptive control of the mowing robot is completed through the control system. Before processing and analyzing the real-time operation environment image in S4, processing weight allocation is performed on the real-time operation environment image, the processing weight allocation including: performing weight allocation based on the area proportion of the near-field environment image portion and an area proportion of the far-field environment image portion in the real-time operation environment image, the higher the area proportion of an image is, the higher a processing weight allocated to the image is, and the more system resources are allocated when processing the image. A sum of a processing weight of the near-field environment image portion and a processing weight of the far-field environment image portion is equal to 1.

In some embodiments, the control system processes the near-field environment image portion and the far-field environment image portion simultaneously.

In some embodiments, the processing and analyzing the real-time operation environment image by using an image processing technique includes:

S4.1, splitting the real-time operation environment image into a plurality of grid blocks, and extracting a texture feature of each of the plurality of grid blocks, respectively.

S4.2, performing classification discrimination on each of the plurality of grid blocks by using the trained SVM model.

S4.3, performing image segmentation based on the classification of each of the plurality of grid blocks to obtain a binary image, so that the real-time operation environment image exhibits a black-and-white effect, to achieve identification of the obstacle.

In some embodiments, in S4.1, the image feature extraction is performed by using a gray-level co-occurrence matrix (GLCM) feature extraction technique, for two gray levels i and j, a direction of each of two grid blocks corresponding to the two gray levels in an image plane is e and a step size between the two grid blocks is d, setting f(x, y) to represent a real-time operation environment image of a size M×N with a count of gray levels L, then elements of a gray-level co-occurrence matrix ((L×L)) are shown in Equation (1):

$$p ( i , j , d , θ ) = \# \{ ( {x}_{1} , {y}_{1} ) , ( {x}_{2} , {y}_{2} ) \} ∈ M \times N \vert f ( {x}_{1} , {y}_{1} ) = i , f ( {x}_{2} , {y}_{2} ) = j . \qquad ( 1 )$$

In Equation (1), #{x} denotes solving for a count of elements x in the set, and 0≤i, j≤L⁻¹.

In some embodiments, when calculating texture features by using the gray-level co-occurrence matrix, the larger the count of gray levels is, the larger a count of statistically obtained texture features is, gray level reduction processing is performed on the real-time operation environment image, and the count of gray levels L and the step size d of the gray-level co-occurrence matrix are determined by establishing an experimental model, including:

Selecting a plurality of lawn images of a lawn and a plurality of images containing the obstacle, randomly selecting 10 sample image blocks from the plurality of lawn images and the plurality of images containing the obstacle to obtain sample image databases with the count of gray levels L being set to 8, 16, and 32, respectively.

Extracting effective texture features from each of the sample image databases, and obtaining a set of 16 features (4 directions×4 texture features) derived from directions 0°, 45°, 90°, and 135°.

Sequentially setting the count of gray levels L to 8, 16, and 32, incrementally changing the step size d within a range of [0, 15], determining a mean value of texture features of the lawn and a mean value of texture features of the obstacle under each of a plurality of combinations of L and d through statistical calculation, and determining a difference between the two mean values. Determining the difference between the mean value of the texture features of the lawn and the mean value of the texture features of the obstacle based on each of different counts of gray levels and statistical step sizes.

For each of the counts of gray levels of 8, 16, and 32, plotting a curve representing a difference between the mean value of the texture features of the lawn and the mean value of the texture features of the obstacle, and selecting a parameter combination that results in a greatest distinction between the texture features of the lawn and the texture features of the obstacle.

Through statistical calculation, selecting the count of gray levels L and the step size d as 16 and 1, respectively.

In some embodiments, the control system may construct, based on the parameter combination, a dataset of the texture features of the lawn and the texture features of the obstacle is constructed to train an SVM model; using lawn images and images containing the obstacle, 16-dimensional data is formed by using 16 combinations derived from the directions 0°, 45°, 90°, and 135°, as well as energy, entropy, contrast, and inverse difference moment, the 16-dimensional data is simultaneously normalized to a preset range to obtain a plurality of training samples and a plurality of test samples, and classification training is performed on the SVM model using the plurality of training samples.

In some embodiments, the obstacle avoidance range of the mowing robot exceeds an obstacle range by at least 10%. When the mowing robot travels according to an initial path and detects that the obstacle exists on the initial path, determining whether the mowing robot is able to travel within a valid region corresponding to the initial path and bypass the obstacle. The valid region corresponding to the initial path is a region formed by expanding outward within a range of 180° to a left side and a right side in front of a travel direction of the mowing robot, with a position of the mowing robot along the initial path as a center.

In some embodiments, in response to determining that the mowing robot is able to bypass the obstacle, the control system controls the mowing robot to bypass the obstacle and travel within the valid region corresponding to the initial path.

In some embodiments, in response to determining that the mowing robot is not able to bypass the obstacle when travelling within the valid region, the control system re-plans a new path, and controlling the mowing robot to bypass the obstacle and travel on the new path.

The foregoing has shown and described the basic principles and main features of the present disclosure and the advantages of the present disclosure. Those skilled in the art should understand that the present disclosure is not limited by the foregoing embodiments. The foregoing embodiments and the description in the present disclosure merely illustrate the principles of the present disclosure. Without departing from the spirit and scope of the present disclosure, the present disclosure may have various changes and improvements, and these changes and improvements fall within the scope of the present disclosure as claimed. The scope of the present disclosure is defined by the appended claims and their equivalents.

What is claimed is:

1. A method for adaptive mowing control of a mowing robot, comprising:
S1, acquiring a real-time operation environment image and trajectory motion information of the mowing robot;
S2, adaptively controlling an effective imaging distance for the mowing robot to capture the real-time operation environment image based on an ambient lighting environment during a current mowing operation, wherein the adaptive control of the effective imaging distance of the real-time operation environment image in S2 comprises: configuring a photosensitive sensor disposed on the mowing robot to acquire forward light intensity information during the current mowing operation, comparing current light intensity information with a standard light intensity range to identify standard light intensity information having a same light intensity within the standard light intensity range, and adaptively controlling the effective imaging distance for the mowing robot to capture the real-time operation environment image based on distance data corresponding to the standard light intensity information; in response to the current light intensity information being lower than a lowest threshold value of the standard light intensity range, stopping acquiring the real-time operation environment image of the mowing robot and stopping the mowing operation; in response to the current light intensity information being higher than a highest threshold value of the standard light intensity range, controlling the effective imaging distance for the mowing robot to capture the real-time operation environment image based on distance data corresponding to the highest threshold value of the standard light intensity range;
S3, performing block segmentation on the real-time operation environment image to divide the real-time operation environment image into a near-field environment image portion and a far-field environment image portion based on an operation travel speed of the mowing robot and using the effective imaging distance as a segmentation parameter, wherein the near-field environment image portion is an image radiating outward from the mowing robot as a center and does not exceed one quarter of an area of the real-time operation environment image, and the far-field environment image portion includes all portions of the real-time operation environment image excluding the near-field environment image portion, a maximum operation travel speed is positively proportional to an area proportion of the near-field environment image portion in the real-time operation environment image, and the area proportion of the near-field environment image portion in the real-time operation environment image does not exceed 25%, wherein the area proportion of the near-field environment image portion is related to ambient light intensity, and the higher the ambient light intensity is, the larger the area proportion of the near-field environment image portion is;
S4, processing and analyzing the real-time operation environment image by using an image processing technique to identify and determine an obstacle;
S5, when the obstacle is identified in the real-time operation environment image, obtaining an obstacle type, and simultaneously obtaining an obstacle avoidance range corresponding to the obstacle type; and
S6, controlling the mowing robot to perform proactive obstacle avoidance based on the obstacle avoidance range; wherein
the acquisition of the real-time operation environment image and the trajectory motion information of the mowing robot is accomplished by a camera and a position sensor, respectively; the camera is configured to acquire a fan-shaped image area in front of the mowing robot during the mowing operation, send the acquired image information to a trained Support Vector Machine (SVM) model for image recognition and classification, and identify the obstacle type of the obstacle in front of the mowing robot during the mowing operation and obtain a bounding box and confidence information; the position sensor is configured to acquire real-time position data of the mowing robot, so as to plan a travel path;
the effective imaging distance is positively proportional to the forward light intensity information during the mowing operation; the higher the current light intensity information is, the longer the effective imaging distance is; conversely, the lower the current light intensity information is, the shorter the effective imaging distance is; the operation travel speed of the mowing robot is limited by the effective imaging distance of the mowing robot; when performing the mowing operation to meet mowing standards, the mowing robot adaptively controls the operation travel speed; the operation travel speed is limited by the imaging distance of the real-time operation environment image: the longer the effective imaging distance is, the higher the maximum operation travel speed of the mowing robot is; when the effective imaging distance reaches a critical distance, the maximum operation travel speed of the mowing robot is set to a highest allowable limit;
a control system for controlling operation of the mowing robot is provided inside the mowing robot, and the adaptive control of the mowing robot is completed through the control system; before processing and analyzing the real-time operation environment image in step S4, processing weight allocation is performed on the real-time operation environment image, the processing weight allocation comprising: performing weight allocation based on the area proportion of the near-field environment image portion and an area proportion of the far-field environment image portion in the real-time operation environment image, wherein the higher the area proportion of an image portion is, the higher a processing weight allocated to the image portion is, and the more system resources are allocated when processing the image portion; a sum of a processing weight of the near-field environment image portion and a processing weight of the far-field environment image portion is equal to 1;
wherein the control system processes the near-field environment image portion and the far-field environment image portion simultaneously.

2. The method for adaptive mowing control of the mowing robot according to claim 1, wherein the processing and analyzing the real-time operation environment image by using an image processing technique comprises:
S4.1, splitting the real-time operation environment image into a plurality of grid blocks, and extracting a texture feature of each of the plurality of grid blocks, respectively;
S4.2, performing classification discrimination on each of the plurality of grid blocks by using the trained Support Vector Machine (SVM) model; and
S4.3, performing image segmentation based on a classification of each of the plurality of grid blocks to obtain a binary image, so that the real-time operation environment image exhibits a black-and-white effect, to achieve identification of the obstacle.

3. The method for adaptive mowing control of the mowing robot according to claim 2, wherein in step S4.1, the image feature extraction is performed by using a gray-level co-occurrence matrix (GLCM) feature extraction technique, wherein for two gray levels i and j, a direction and a step length in an image plane for pixel pairs corresponding to the two gray levels are set as θ and d, respectively, and setting f(x, y) to represent a real-time operation environment image of a size M×N with a count of gray levels L, then elements of a gray-level co-occurrence matrix (L×L) are shown in Equation (1):
$$p ( i , j , d , θ ) = \# \{ ( {x}_{1} , {y}_{1} ) , ( {x}_{2} , {y}_{2} ) \} ∈ M \times N \vert f ( {x}_{1} , {y}_{1} ) = i , f ( {x}_{2} , {y}_{2} ) = j \qquad ( 1 )$$
wherein #{x} denotes solving for a count of elements x in the set, and 0≤i, j≤L⁻¹.

4. The method for adaptive mowing control of the mowing robot according to claim 3, wherein when calculating texture features by using the gray-level co-occurrence matrix, the larger the count of gray levels is, the larger a count of statistically obtained texture features is, gray level reduction processing is performed on the real-time operation environment image, and the count of gray levels L and the step size d of the gray-level co-occurrence matrix are determined by establishing an experimental model, comprising:
selecting a plurality of lawn images of a lawn and a plurality of images containing the obstacle, randomly selecting 10 sample image blocks from the plurality of lawn images and the plurality of images containing the obstacle to obtain sample image databases with the count of gray levels L being set to 8, 16, and 32, respectively;
extracting effective texture features from each of the sample image blocks in each of the sample image databases, and obtaining a set of 16 features (4 directions×4 texture features) derived from directions 0°, 45°, 90°, and 135° for each of the sample image blocks in each of the sample image databases;
sequentially setting the count of gray levels L to 8, 16, and 32, incrementally changing the step size d within a range of [0,15], determining a mean value of texture features of the lawn and a mean value of texture features of the obstacle under each of a plurality of combinations of L and d through statistical calculation, and determining a difference between the two mean values; determining the difference between the mean value of the texture features of the lawn and the mean value of the texture features of the obstacle based on each of different counts of gray levels and statistical step sizes;
for each of the counts of gray levels of 8, 16, and 32, plotting a curve representing a difference between the mean value of the texture features of the lawn and the mean value of the texture features of the obstacle, and selecting a parameter combination that results in a greatest distinction between the texture features of the lawn and the texture features of the obstacle;
through statistical calculation, selecting the count of gray levels L and the step size d as 16 and 1, respectively.

5. The method for adaptive mowing control of the mowing robot according to claim 4, wherein based on the parameter combination, a dataset of the texture features of the lawn and the texture features of the obstacle is constructed to train an SVM model; using lawn images and images containing the obstacle, 16-dimensional data is formed by using 16 combinations derived from the directions 0°, 45°, 90°, and 135°, as well as energy, entropy, contrast, and inverse difference moment, the 16-dimensional data is simultaneously normalized to a preset range to obtain a plurality of training samples and a plurality of test samples, and classification training is performed on the SVM model using the plurality of training samples.

6. The method for adaptive mowing control of the mowing robot according to claim 5, wherein the obstacle avoidance range of the mowing robot exceeds an obstacle range by at least 10%; when the mowing robot travels according to an initial path and detects that the obstacle exists on the initial path, determining whether the mowing robot is able to travel within a valid region corresponding to the initial path and bypass the obstacle, wherein the valid region corresponding to the initial path is a region formed by expanding outward within a range of 180° to a left side and a right side in front of a travel direction of the mowing robot, with a position of the mowing robot along the initial path as a center;
in response to determining that the mowing robot is able to bypass the obstacle, controlling the mowing robot to bypass the obstacle and travel within the valid region corresponding to the initial path;
in response to determining that the mowing robot is not able to bypass the obstacle when travelling within the valid region, re-planning a new path, and controlling the mowing robot to bypass the obstacle and travel on the new path.

7. The method for adaptive mowing control of the mowing robot according to claim 1, further comprising:
determining a fluctuation degree of a plurality of ambient light intensities within a preset period;
in response to the fluctuation degree satisfying a fluctuation condition, processing the plurality of ambient light intensities to obtain a target light intensity;
re-determining the effective imaging distance based on the target light intensity;
in response to the fluctuation degree not satisfying the fluctuation condition, maintaining the original effective imaging distance.

8. The method for adaptive mowing control of the mowing robot according to claim 1, further comprising:
determining a light intensity trend based on historical light intensities;
in response to the light intensity trend being a weakening trend, shortening the effective imaging distance and reducing the maximum operation travel speed.

9. The method for adaptive mowing control of the mowing robot according to claim 8, further comprising:
determining, based on the light intensity trend, a remaining battery level of the mowing robot, and the trajectory motion information, whether the mowing robot is able to complete the mowing operation and return for charging before the ambient light intensity satisfies a lighting condition;
in response to determining that the mowing robot is unable to complete the mowing operation and return for charging before the ambient light intensity satisfies the lighting condition, controlling the mowing robot to return in advance;
in response to determining that the mowing robot is able to complete the mowing operation and return for charging before the ambient light intensity satisfies the lighting condition, controlling the mowing robot to continue performing the mowing operation.
